(19) United States
(12) Patent Application Publication
(10) Pub. No.: US 2020/0328449 A1
(43) Pub. Date: Oct. 15, 2020

(54) BATTERY ELECTRODE GROUP, WOUND TYPE BATTERY INCLUDING SAME ELECTRODE GROUP, AND METHOD OF MANUFACTURING BATTERY ELECTRODE GROUP

(71) Applicant: HONDA MOTOR CO., LTD., Tokyo (JP)

(72) Inventors: Masahiro Ohta, Wako-shi (JP); Wataru Shimizu, Wako-shi (JP)

(21) Appl. No.: 16/840,481

(22) Filed: Apr. 6, 2020

(30) Foreign Application Priority Data
Apr. 10, 2019 (JP) 2019-074861

(51) Int. Cl. H01M 10/058; H01M 10/0525; H01M 4/139; H01M 4/36

(52) U.S. Cl. CPC H01M 10/058; H01M 4/364; H01M 4/139; H01M 10/0525

(57) ABSTRACT

The battery electrode group 1 is formed of a laminate 2 which includes a positive electrode layer 10 having a positive electrode active material layer 12 formed on an elongated positive electrode current collector 11 and a negative electrode layer 20 having a negative electrode active material layer 22 formed on an elongated negative electrode current collector 21, and in which the positive electrode layer 10 and the negative electrode layer 20 are wound in a flat shape. A longitudinal end portion 10a of the positive electrode layer constitutes a winding core of the laminate 2.

### CROSS-REFERENCE TO RELATED APPLICATION

Priority is claimed on Japanese Patent Application No. 2019-074861, filed Apr. 10, 2019, the content of which is incorporated herein by reference.

### BACKGROUND OF THE INVENTION

### Field of the Invention

The present disclosure relates to a battery electrode group, a wound type battery including the electrode group, and a method of manufacturing the battery electrode group.

### Description of Related Art

In order to secure and maintain a performance at the time of design, a solid-state battery, in a state of being formed as a laminate, needs to be press-formed at a high surface pressure to have a high confining pressure thereafter. Therefore, when an electrode group is formed by winding, electrodes need to be in a flat shape. In a wound type cell found in a conventional lithium ion battery (aqueous LIB), a nickel metal hydride (NiMH) battery, or the like, a separator or paper that does not function as a battery is provided at a winding start portion (core).

For example, a secondary battery includes an electrode group in a flat shape formed by winding a positive electrode plate having a positive electrode mixture layer formed on a positive electrode current collector and a negative electrode plate having a negative electrode mixture layer formed on a negative electrode current collector with a separator interposed therebetween. In such an electrode group, a separator is disposed substantially at a center of the cross section in a radial direction (Patent Document 1).

Also, a cylindrical sealed lead-acid battery includes an electrode group in which a separator is interposed between a positive electrode plate and a negative electrode plate with current collectors in a flat shape filled with an active material, and a part of the separator is disposed substantially at a center of the cross section in a radial direction (Patent Document 2).

### PATENT DOCUMENTS

[Patent Document 1] Japanese Patent Publication No. 4744617

[Patent Document 2] Japanese Patent Publication No. 4852779

### SUMMARY OF THE INVENTION

However, when a battery is manufactured, since an all-solid-state battery generally is press-formed as an assembly package by winding a positive electrode and a negative electrode, variations in surface pressure applied to electrodes and a positional deviation are likely to occur, and as a result, there is a problem in that variations in an initial performance of the battery and falling off of an electrode mixture are caused, and thus a yield is deteriorated. Also, when a member such as a separator that does not function as a battery is disposed as a core, the core is a dead space and thus serves as a factor that lowers the volume energy density of the battery.

An objective of the present disclosure is to provide a battery electrode group, a wound type battery including the electrode group, and a method of manufacturing the battery electrode group in which improvement in yield of a battery and improvement in volume energy density can be achieved.

In order to achieve the above-described objective, the present disclosure provides the following methods.

[1] A battery electrode group formed of a laminate which includes a positive electrode layer having a positive electrode active material layer formed on an elongated positive electrode current collector, and a negative electrode layer having a negative electrode active material layer formed on an elongated negative electrode current collector, and in which the positive electrode layer and the negative electrode layer are wound in a flat shape, wherein one of a longitudinal end portion of the positive electrode layer and a longitudinal end portion of the negative electrode layer constitutes a winding core of the laminate.

[2] The battery electrode group according to the above-described [1], in which the positive electrode layer includes the elongated positive electrode current collector, and a plurality of positive electrode active material layers intermittently formed on at least one main surface of the positive electrode current collector, the negative electrode layer includes the elongated negative electrode current collector, and a plurality of negative electrode active material layers intermittently formed on at least one main surface of the negative electrode current collector, and the plurality of positive electrode active material layers and the plurality of negative electrode active material layers are alternately disposed with respect to a lamination direction of the laminate in a state in which the positive electrode layer and the negative electrode layer are wound.

[3] The battery electrode group according to the above-described [1] in which a thickness of the positive electrode active material layer positioned at the longitudinal end portion of the positive electrode layer is larger than thicknesses of the positive electrode active material layers at positions other than the longitudinal end portion of the positive electrode layer, or a thickness of the negative electrode active material layer positioned at the longitudinal end portion of the negative electrode layer is larger than thicknesses of the negative electrode active material layers at positions other than the longitudinal end portion of the negative electrode layer.

[4] The battery electrode group according to the above-described [1], in which a basis weight of the positive electrode active material layer positioned at the longitudinal end portion of the positive electrode layer is larger than basis weights of the positive electrode active material layers at positions other than the longitudinal end portion of the positive electrode layer, or a basis weight of the negative electrode active material layer positioned at the longitudinal end portion of the negative electrode layer is larger than basis weights of the negative electrode active material layers at positions other than the longitudinal end portion of the negative electrode layer.

[5] The battery electrode group according to the above-described [1] including a first solid electrolyte layer disposed between the positive electrode layer and the negative electrode layer, and a second solid electrolyte layer disposed on a side of the negative electrode layer opposite to the first solid electrolyte layer.

[6] The battery electrode group according to the above-described [1] further including an elongated third solid electrolyte layer integrally disposed on both sides of the positive electrode layer in a bent state or integrally disposed on both sides of the negative electrode layer in a bent state.

[7] The battery electrode group according to the above-described [1] further including an elongated first separator disposed between the positive electrode layer and the negative electrode layer, and an elongated second separator disposed on a side of the negative electrode layer opposite to the first separator.

[8] The battery electrode group according to any one of the above-described [1] further including an elongated third separator integrally disposed on both sides of the positive electrode layer in a bent state, or integrally disposed on both sides of the negative electrode layer in a bent state.

[9] A wound type battery including a battery electrode group according to the above-described [1].

[10] A method of manufacturing a battery electrode group, in which a positive electrode layer including a positive electrode active material layer formed on an elongated positive electrode current collector and a negative electrode layer including a negative electrode active material layer formed on an elongated negative electrode current collector are laminated in a state of being deviated from each other in a longitudinal direction so that winding start positions of the positive electrode layer and the negative electrode layer are different, and the positive electrode layer and the negative electrode layer are wound in a flat shape to form a laminate using any one of a longitudinal end portion of the positive electrode layer and a longitudinal end portion of the negative electrode layer as a winding core.

[11] The method of manufacturing a battery electrode group according to the above-described [10], in which the positive electrode layer is manufactured by intermittently forming a plurality of positive electrode active material layers on at least one main surface of the positive electrode current collector, the negative electrode layer is manufactured by intermittently forming a plurality of negative electrode active material layers on at least one main surface of the negative electrode current collector, and the plurality of positive electrode active material layers and the plurality of negative electrode active material layers are alternately disposed with respect to a lamination direction of the laminate by winding the positive electrode layer and the negative electrode layer.

[12] The method of manufacturing a battery electrode group according to the above-described [10], in which the positive electrode active material layers are formed so that a thickness of the positive electrode active material layer positioned at the longitudinal end portion of the positive electrode layer is larger than thicknesses of the positive electrode active material layers at positions other than the longitudinal end portion of the positive electrode layer, or the negative electrode active material layers are formed so that a thickness of the negative electrode active material layer positioned at the longitudinal end portion of the negative electrode layer is larger than thicknesses of the negative electrode active material layers at positions other than the longitudinal end portion of the negative electrode layer.

[13] The method of manufacturing a battery electrode group according to the above-described [10], in which the positive electrode active material layers are formed so that a basis weight of the positive electrode active material layer positioned at the longitudinal end portion of the positive electrode layer is larger than basis weights of the positive electrode active material layers at positions other than the longitudinal end portion of the positive electrode layer, or the negative electrode active material layers are formed so that a basis weight of the negative electrode active material layer positioned at the longitudinal end portion of the negative electrode layer is larger than basis weights of the negative electrode active material layers at positions other than the longitudinal end portion of the negative electrode layer.

[14] The method of manufacturing a battery electrode group according to the above-described [10], in which a first solid electrolyte layer is disposed between the positive electrode layer and the negative electrode layer, and a second solid electrolyte layer is disposed on a side of the negative electrode layer opposite to the first solid electrolyte layer, and the positive electrode layer, the first solid electrolyte layer, the negative electrode layer, and the second solid electrolyte layer are laminated in this order and wound.

[15] The method of manufacturing a battery electrode group according to the above-described [10], in which an elongated third solid electrolyte layer is bent to be disposed on both sides of the positive electrode layer or disposed on both sides of the negative electrode layer, and one of the positive electrode layer and the negative electrode layer, the third solid electrolyte layer, the other of the positive electrode layer and the negative electrode layer, and the third solid electrolyte layer are laminated in this order and wound.

[16] The method of manufacturing a battery electrode group according to the above-described [10], in which an elongated first separator is disposed between the positive electrode layer and the negative electrode layer, and an elongated second separator is disposed on a side of the negative electrode layer opposite to the first separator, and the positive electrode layer, the first separator, the negative electrode layer, and the second separator are laminated in this order and wound.

[17] The method of manufacturing a battery electrode group according to the above-described [10], in which an elongated third separator is bent to be disposed on both sides of the positive electrode layer or disposed on both sides of the negative electrode layer, and one of the positive electrode layer and the negative electrode layer, the third separator, the other of the positive electrode layer and the negative electrode layer, and the third separator are laminated in this order and wound.

[18] A wound type battery including a battery electrode group manufactured by the manufacturing method according to the above-described [10].

According to the present disclosure, improvement in yield of the wound type battery and improvement in volume energy density can be achieved.

### BRIEF DESCRIPTION OF THE DRAWINGS

FIG. 1 is a cross-sectional view showing an example of a configuration of a battery electrode group according to an embodiment of the present disclosure.

FIG. 2 is an exploded cross-sectional view of a state in which the battery electrode group of FIG. 1 is spread.

FIG. 3(a) is a cross-sectional view showing a modified example of a positive electrode layer in FIG. 2, and FIG. 3(b) is a cross-sectional view showing another modified example of the positive electrode layer in FIG. 2.

FIG. 4(a) is a cross-sectional view showing another modified example of the battery electrode group of FIG. 2, and FIG. 4(b) is a cross-sectional view showing a modified example of the positive electrode layer in FIG. 4(a).

FIG. 5 is a view showing an example of a method of manufacturing a wound type battery including the battery electrode group of FIG. 1.

FIG. 6 is a cross-sectional view showing a modified example of the battery electrode group of FIG. 2.

### DETAILED DESCRIPTION OF THE INVENTION

Hereinafter, embodiments of the present disclosure will be described in detail with reference to the drawings. In the drawings used in the following description, there are cases in which characteristic portions are enlarged for convenience of illustration so that characteristics of the present embodiment can be easily understood, and dimensional proportions of respective constituent elements may be different from actual ones. Also, materials, dimensions, and the like shown in the following description are merely examples, and the present embodiment is not limited thereto and can be implemented with appropriate modifications within a range in which the effects of the present disclosure are achieved.

### [Configuration of Wound Type Battery]

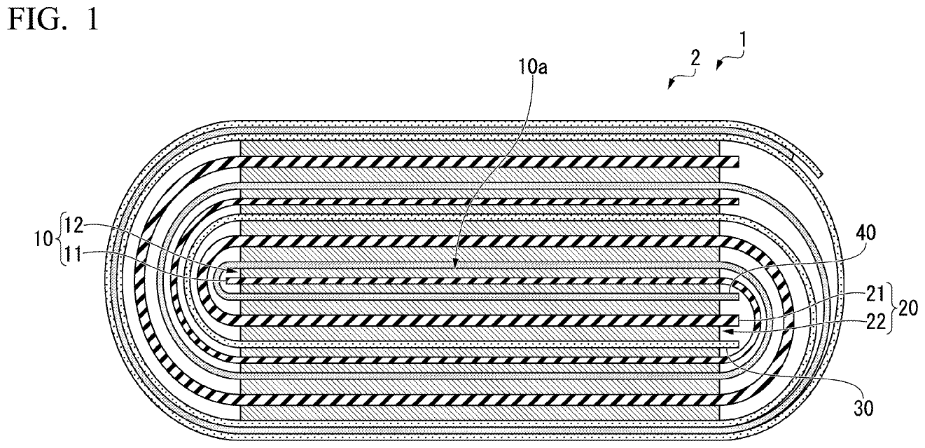

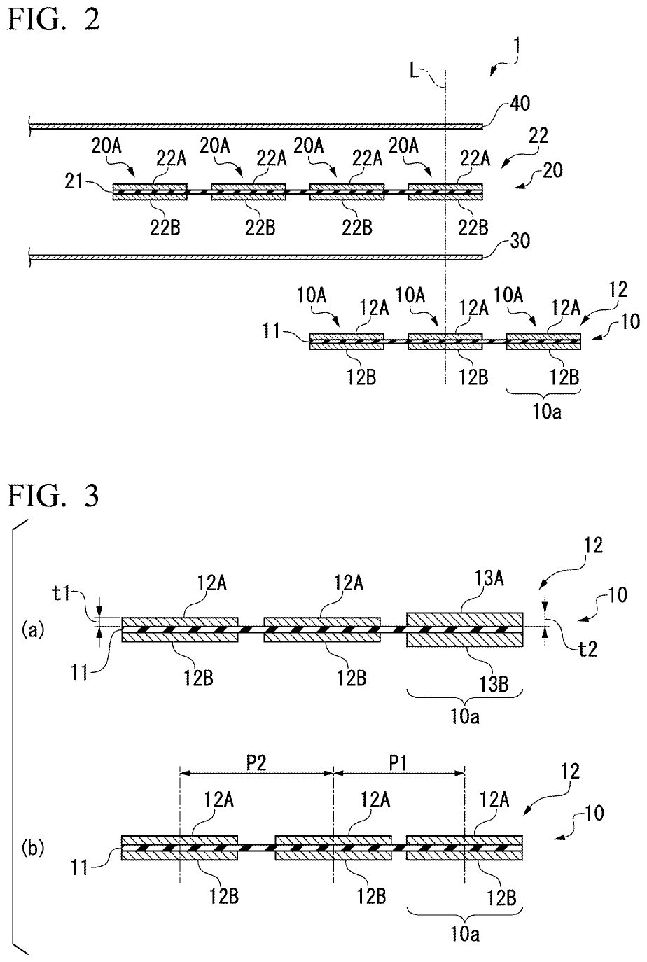

FIG. 1 is a cross-sectional view showing an example of a configuration of a battery electrode group according to an embodiment of the present disclosure, and FIG. 2 is an exploded cross-sectional view of a state in which the battery electrode group of FIG. 1 is spread. In the present embodiment, a wound type all-solid-state battery will be described as an example of a wound type battery. As the wound type all-solid-state battery, an all-solid-state lithium ion secondary battery, an all-solid-state sodium ion secondary battery, an all-solid-state magnesium ion secondary battery, and the like are exemplary examples.

As shown in FIG. 1, the battery electrode group 1 is formed of a laminate 2 which includes a positive electrode layer 10 having a positive electrode active material layer 12 formed on an elongated positive electrode current collector 11 and a negative electrode layer 20 having a negative electrode active material layer 22 formed on an elongated negative electrode current collector 21, and in which the positive electrode layer 10 and the negative electrode layer 20 are wound in a flat shape. In the present embodiment, a longitudinal end portion 10a of the positive electrode layer 10 constitutes a winding core of the laminate 2.

As shown in FIG. 2, the positive electrode layer 10 may include, for example, the elongated positive electrode current collector 11 and a plurality of positive electrode active material layers 12A and 12B that are intermittently formed on both main surfaces of the positive electrode current collector 11. In the present embodiment, a pair of positive electrode active material layers 12A and 12B formed on both main surfaces of the positive electrode current collector 11 define a positive electrode layer unit 10A, and a plurality of positive electrode layer units 10A constitute the positive electrode layer 10. However, the positive electrode layer 10 may include a plurality of positive electrode active material layers 12A (or a plurality of positive electrode active material layers 12B) that are intermittently formed only on one main surface of the positive electrode current collector 11. Also, the positive electrode current collector 11 and the positive electrode active material layers 12A and 12B may be integrated to form the positive electrode layer 10.

The positive electrode current collector 11 is preferably formed of at least one material having high conductivity. As a material having high conductivity, a metal or alloy such as stainless steel containing at least one metal element of, for example, silver (Ag), palladium (Pd), gold (Au), platinum (Pt), aluminum (Al), copper (Cu), chromium (Cr), and nickel (Ni), or a non-metal such as carbon (C) is an exemplary example. When manufacturing costs are considered in addition to the high conductivity, aluminum, nickel, or stainless steel is preferable. Further, aluminum (Al) does not easily react with a positive electrode active material, a negative electrode active material, and a solid electrolyte. Therefore, when aluminum (Al) is used for the positive electrode current collector 11, an internal resistance of the all-solid-state battery can be reduced.

As a form of the positive electrode current collector 11, a foil form, a plate form, a mesh form, a nonwoven fabric form, a foam form, and the like are exemplary examples. Also, in order to enhance adhesion to the positive electrode active material layers 12A and 12B, carbon or the like may be disposed on surfaces of the positive electrode current collector 11, or the surfaces may be roughened.

The positive electrode active material layers 12A and 12B contain a positive electrode active material that allows transfer of, for example, lithium ions and electrons thereto and therefrom. The positive electrode active material is not particularly limited as long as the material can release and occlude lithium ions reversibly and can transport electrons, and a known positive electrode active material applicable to a positive electrode layer of an all-solid-state lithium ion battery can be used. Complex oxides such as lithium cobalt oxide (LiCoO₂), lithium nickel oxide (LiNiO₂), lithium manganese oxide (LiMn₂O₄), solid solution oxide (Li₂MnO₃—LiMO₂ (M=Co, Ni, or the like)), lithium-manganese-nickel-cobalt oxide (LiNi_{1/3}Mn_{1/3}CO_{1/3}O₂), and olivine-type lithium phosphate (LiFePO₄); conductive polymers such as polyaniline and polypyrrole; sulfides such as Li₂S, CuS, Li—Cu—S compounds, TiS₂, FeS, MoS₂, and Li—Mo—S compounds; a mixture of sulfur and carbon; and the like are exemplary examples. The positive electrode active material may be formed of one of the above-described materials alone or may be formed of two or more thereof.

The positive electrode active material layers 12A and 12B include a solid electrolyte that allows lithium ions to be transferred to and from the positive electrode active material. The solid electrolyte is not particularly limited as long as it has lithium ion conductivity, and a material generally used for all-solid-state lithium ion batteries can be used. Inorganic solid electrolytes such as a sulfide solid electrolyte material, an oxide solid electrolyte material, or a lithium-containing salt, polymer-based solid electrolytes such as polyethylene oxide, gel-based solid electrolytes containing a lithium-containing salt or ionic liquids having lithium ion conductivity, and the like are exemplary examples. The solid electrolyte may be formed of one of the above-described materials alone or may be formed of two or more thereof.

The solid electrolyte included in the positive electrode active material layers 12A and 12B may be the same as or different from a solid electrolyte included in negative electrode active material layers 22A and 22B or a solid electrolyte layer to be described below.

The positive electrode active material layers 12A and 12B may contain a conductive auxiliary agent from a viewpoint of improving conductivity of the positive electrode layer 10. As the conductive auxiliary agent, a conductive auxiliary agent that can generally be used for all-solid-state lithium ion batteries can be used. Carbon black such as acetylene black or Ketjen black; carbon fibers; vapor-grown carbon fibers; graphite powder; and carbon materials such as carbon nanotubes are exemplary examples. The conductive auxiliary agent may be formed of one of the above-described materials alone or may be formed of two or more thereof.

Also, the positive electrode active material layers 12A and 12B may contain a binder having a role of binding the positive electrode active materials to each other and binding the positive electrode active material and the current collector.

A thickness of the positive electrode layer 10 is preferably 10 μm or more and 1000 μm or less, and more preferably 70 μm or more and 1000 μm or less. When the thickness of the positive electrode layer 10 is 70 μm or more, a rigidity of the longitudinal end portion 10a of the positive electrode layer 10 constituting the winding core can be increased, and variations in surface pressure applied to the electrodes and a positional deviation therebetween can be prevented when the laminate 2 is press-formed. On the other hand, when the thickness of the positive electrode layer 10 exceeds 1000 μm, it is not preferable because a positive electrode resistance increases significantly.

A thickness and a basis weight of the plurality of positive electrode active material layers 12A and 12B are basically the same as each other but may be different. For example, as shown in FIG. 3(a), a thickness t2 of positive electrode active material layers 13A and 13B positioned at the longitudinal end portion 10a of the positive electrode layer 10 may be larger than thicknesses t1 of the positive electrode active material layers 12A and 12B at positions other than the longitudinal end portion 10a of the positive electrode layer 10. Also, a basis weight of the positive electrode active material layers 13A and 13B (or the positive electrode active material layers 12A and 12B) positioned at the longitudinal end portion 10a of the positive electrode layer 10 may be larger than basis weights of the positive electrode active material layers 12A and 12B at positions other than the longitudinal end portion 10a of the positive electrode layer 10. Thereby, the rigidity of the longitudinal end portion 10a of the positive electrode layer 10 constituting the winding core can be increased.

Also, an arrangement pitch of the plurality of positive electrode active material layers 12A and 12B is basically uniform, but the arrangement pitch may vary. For example, as shown in FIG. 3(b), an arrangement pitch of the plurality of positive electrode active material layers 12A and 12B preferably increases from one end (the longitudinal end portion 10a) toward the other end in a longitudinal direction of the positive electrode layer 10. In other words, it is preferable that an interval between adjacent positive electrode active material layers 12A and 12A increase from one end (the longitudinal end portion 10a) toward the other end in the longitudinal direction of the positive electrode layer 10. Thereby, the positive electrode layer 10 can easily be wound, and weight reduction and cost reduction can be achieved by providing the positive electrode active electrolyte as little as possible in a folded portion that does not function as a battery.

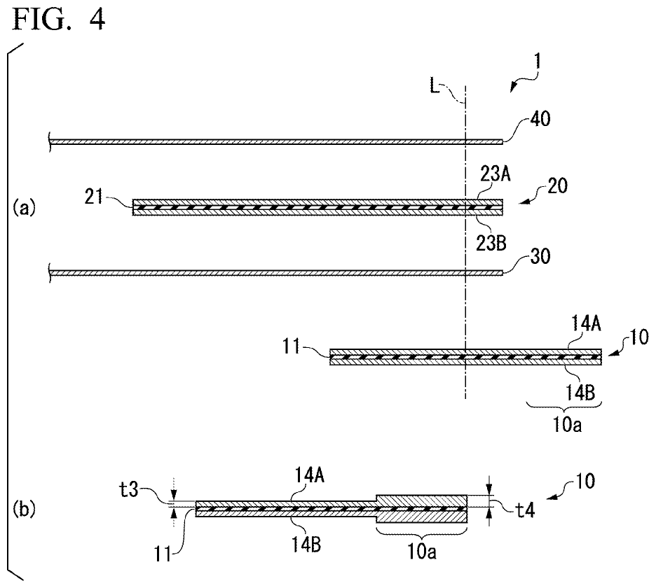

The positive electrode layer 10 includes the plurality of positive electrode active material layers 12A and 12B that are intermittently formed on both main surfaces of the positive electrode current collector 11, but the present disclosure is not limited thereto. For example, as shown in FIG. 4(a), the positive electrode layer 10 may include positive electrode active material layers 14A and 14B that are continuously formed on both main surfaces of the positive electrode current collector 11. Also, the positive electrode layer 10 may include the positive electrode active material layer 14A (or the positive electrode active material layer 14B) that is continuously formed on one main surface of the positive electrode current collector 11. Further, in the positive electrode layer 10, as shown in FIG. 4(b), a thickness t4 of the positive electrode active material layers 14A and 14B at the longitudinal end portion 10a of the positive electrode layer 10 may be larger than a thickness t3 of the positive electrode active material layers 14A and 14B constituting the positive electrode layer 10.

The negative electrode layer 20 includes the elongated negative electrode current collector 21 and a plurality of negative electrode active material layers 22A and 22B that are intermittently formed on both main surfaces of the negative electrode current collector 21 (FIG. 2). In the present embodiment, a pair of negative electrode active material layers 22A and 22B define a negative electrode layer unit 20A, and a plurality of negative electrode layer units 20A constitute the negative electrode layer 20. However, the negative electrode layer 20 may include a plurality of negative electrode active material layers 22A (or a plurality of negative electrode active material layers 22B) that are intermittently formed only on one main surface of the negative electrode current collector 21. Also, the negative electrode current collector 21 and the negative electrode active material layers 22A and 22B may be integrated to form the negative electrode layer 20.

Similarly to the positive electrode current collector 11, the negative electrode current collector 21 is preferably formed of at least one material having high conductivity. As a material having high conductivity, a metal or alloy such as stainless steel containing at least one metal element of, for example, silver (Ag), palladium (Pd), gold (Au), platinum (Pt), aluminum (Al), copper (Cu), chromium (Cr), and nickel (Ni), or a non-metal such as carbon (C) is an exemplary example. When manufacturing costs are considered in addition to the high conductivity, copper, nickel, or stainless steel is preferable. Further, stainless steel does not easily react with a positive electrode active material, a negative electrode active material, and a solid electrolyte. Therefore, when stainless steel is used for the negative electrode current collector 21, the internal resistance of the all-solid-state battery can be reduced.

As a form of the negative electrode current collector 21, a foil form, a plate form, a mesh form, a nonwoven fabric form, a foam form, and the like are exemplary examples. Also, in order to enhance adhesion to the negative electrode active material layers 22A and 22B, carbon or the like may be disposed on surfaces of the negative electrode current collector 21, or the surfaces thereof may be roughened.

The negative electrode active material layers 22A and 22B contain a negative electrode active material that allows transfer of lithium ions and electrons thereto and therefrom. The negative electrode active material is not particularly limited as long as the material can release and occlude lithium ions reversibly and can transport electrons, and a known negative electrode active material applicable to a negative electrode layer of an all-solid-state lithium ion battery can be used. Carbonaceous materials such as natural graphite, artificial graphite, resinous coal, carbon fibers, activated carbon, hard carbon, and soft carbon; alloy-based materials mainly formed of tin, tin alloy, silicon, silicon alloy, gallium, gallium alloy, indium, indium alloy, aluminum, aluminum alloy, and the like; conductive polymers such as polyacene, polyacetylene, and polypyrrole; metallic lithium; lithium-titanium complex oxides (for example, Li₄Ti₅O₁₂), and the like are exemplary examples. These negative electrode active materials may be formed of one of the above-described materials alone or may be formed of two or more thereof.

The negative electrode active material layers 22A and 22B include a solid electrolyte that allow lithium ions to be transferred to and from the negative electrode active material. The solid electrolyte is not particularly limited as long as it has lithium ion conductivity, and materials generally used for all-solid-state lithium ion batteries can be used. Inorganic solid electrolytes such as a sulfide solid electrolyte material, an oxide solid electrolyte material, and a lithium-containing salt, polymer-based solid electrolytes such as polyethylene oxide, gel-based solid electrolytes containing a lithium-containing salt or ionic liquids having lithium ion conductivity, and the like are exemplary examples. The solid electrolyte may be formed of one of the above-described materials alone or may be formed of two or more thereof.

The solid electrolyte included in the negative electrode active material layers 22A and 22B may be the same as or different from the solid electrolyte included in the positive electrode active material layers 12A and 12B or in a solid electrolyte layer to be described below.

The negative electrode active material layer 22B may contain a conductive auxiliary agent, a binder, or the like. Although there is no particular limitation on these materials, for example, the same materials as those used for the positive electrode active material layer 12B described above can be used.

Although there is no particular limitation on a thickness of the negative electrode layer 20, the thickness may be, for example, 10 μm or more and 1000 μm or less.

The negative electrode layer 20 includes the plurality of negative electrode active material layers 22A and 22B that are intermittently formed on both main surfaces of the negative electrode current collector 21, but the present disclosure is not limited thereto. For example, as shown in FIG. 4(a), the negative electrode layer 20 may include negative electrode active material layers 23A and 23B that are continuously formed on both main surfaces of the negative electrode current collector 21. Also, the negative electrode layer 20 may include the negative electrode active material layer 23A (or the negative electrode active material layer 23B) that is continuously formed on one main surface of the negative electrode current collector 21.

In the present embodiment, a longitudinal end portion of the negative electrode layer 20 constitutes the winding core of the laminate 2, but the present disclosure is not limited thereto, and the positive electrode layer 10 and the negative electrode layer 20 may be disposed at opposite positions so that a longitudinal end portion of the negative electrode layer 20 constitutes the winding core of the laminate 2. In this case, a configuration of the negative electrode layer 20 can have the same configuration as that of the positive electrode layer 10 described above.

When the longitudinal end portion of the negative electrode layer 20 constitutes the winding core of the laminate 2, a thickness of the negative electrode active material layers positioned at the longitudinal end portion of the negative electrode layer 20 can be made larger than thicknesses of the negative electrode active material layers at positions other than the longitudinal end portion of the negative electrode layer 20. Also, a basis weight of the negative electrode active material layers positioned at the longitudinal end portion of the negative electrode layer 20 can be made larger than basis weights of the negative electrode active material layers at positions other than the longitudinal end portion of the negative electrode layer 20. Thereby, a rigidity of the longitudinal end portion of the negative electrode layer 20 constituting the winding core can be increased. Also, the negative electrode layer 20 can easily be wound, and weight reduction and cost reduction can be achieved by providing the negative electrode active electrolyte as little as possible in a folded portion that does not function as a battery.

In the laminate 2, in a state in which the positive electrode layer 10 and the negative electrode layer 20 are wound, a plurality of positive electrode active material layers 12 and a plurality of negative electrode active material layers 22 are alternately disposed with respect to a lamination direction of the laminate 2 (FIG. 1). At this time, electrodes positioned on outermost layers (for example, an uppermost layer and a lowermost layer) of the laminate 2 are preferably the negative electrode layers 20 having the negative electrode active material layer 22.

In a plan view of the positive electrode layer 10, areas and shapes of the plurality of positive electrode active material layers 12A and 12B are preferably the same as each other. Thereby, when the laminate 2 is formed, the plurality of positive electrode active material layers 12A and 12B can be laminated with end surfaces thereof aligned.

Also, in a plan view of the negative electrode layer 20, areas and shapes of the plurality of negative electrode active material layers 22A and 22B are preferably the same as each other. Thereby, when the laminate 2 is formed, the plurality of negative electrode active material layers 22A and 22B can be laminated with end surfaces thereof aligned.

Also, the areas and shapes of the positive electrode active material layers 12A and 12B in a plan view of the positive electrode layer 10 may be the same as the areas and shapes of the negative electrode active material layers 22A and 22B in a plan view of the negative electrode layer 20. Alternatively, the areas of the positive electrode active material layers 12A and 12B in a plan view of the positive electrode layer 10 may be smaller than the areas of the negative electrode active material layers 22A and 22B in a plan view of the negative electrode layer 20 while the shapes of the positive electrode active material layers 12A and 12B in a plan view of the positive electrode layer 10 are the same as the shapes of the negative electrode active material layers 22A and 22B in a plan view of the negative electrode layer 20.

The battery electrode group 1 includes a first solid electrolyte layer 30 disposed between the positive electrode layer 10 and the negative electrode layer 20, and a second solid electrolyte layer 40 disposed on a side of the negative electrode layer 20 opposite to the first solid electrolyte layer 30.

The first solid electrolyte layer 30 and the second solid electrolyte layer 40 are each formed of, for example, a solid electrolyte sheet. The solid electrolyte sheet includes, for example, an elongated porous substrate and a solid electrolyte held by the porous substrate. Although there is no particular limitation on a form of the porous substrate, a woven fabric, a nonwoven fabric, a mesh cloth, a porous membrane, an expanding sheet, a punching sheet, and the like are exemplary examples. Among these forms, a nonwoven fabric is preferable from a viewpoint of holding force of the solid electrolyte and handleability.

The porous substrate is preferably formed of an insulating material. Thereby, insulating properties of the solid electrolyte sheet can be improved. As the insulating material, a resin material such as nylon, polyester, polyethylene, polypropylene, polytetrafluoroethylene, ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyetheretherketone, cellulose, or acrylic resin; natural fibers such as hemp, wood pulp, or cotton linters; glass, and the like are exemplary examples.

The above-described solid electrolyte is not particularly limited as long as it has lithium ion conductivity and insulating properties, and materials generally used for all-solid-state lithium ion batteries can be used. Inorganic solid electrolytes such as a sulfide solid electrolyte material, an oxide solid electrolyte material, or a lithium-containing salt, polymer-based solid electrolytes such as polyethylene oxide, gel-based solid electrolytes containing a lithium-containing salt or ionic liquids having lithium ion conductivity, and the like are exemplary examples. Although there is no particular limitation on a form of the solid electrolyte material, for example, a particulate form is an exemplary example.

The first solid electrolyte layer 30 and the second solid electrolyte layer 40 are continuously formed on the solid electrolyte sheet. Thereby, the first solid electrolyte layer 30 and the second solid electrolyte layer 40 can easily be manufactured. However, the first solid electrolyte layer 30 and the second solid electrolyte layer 40 may be intermittently formed on the solid electrolyte sheet in a longitudinal direction thereof. Thereby, the first solid electrolyte layer 30 and the second solid electrolyte layer 40 can easily be wound, and weight reduction and cost reduction can be achieved by providing the solid electrolytes as little as possible in a folded portion that does not function as a battery.

Although the solid electrolyte sheet of the present embodiment has a porous substrate, the present disclosure is not limited thereto, and the solid electrolyte sheet may be formed of a solid electrolyte without having a porous substrate. For example, a solid electrolyte sheet formed of a solid electrolyte can be prepared by applying a solid electrolyte slurry onto a coating substrate such as a polyethylene terephthalate (PET) film, drying it, performing rolling processing as necessary, and then peeling it off from the coating substrate. Also, the first solid electrolyte layer 30 and the second solid electrolyte layer 40 may also be formed by applying the solid electrolyte slurry onto a main surface of the positive electrode layer 10 or the negative electrode layer 20 that faces a counter electrode, drying it, and performing rolling processing as necessary. The first solid electrolyte layer 30 and the second solid electrolyte layer 40 may be provided on one of the positive electrode layer 10 and the negative electrode layer 20, or may be provided on both.

Also, the first solid electrolyte layer 30 and the second solid electrolyte layer 40 may contain a pressure-sensitive adhesive for imparting a mechanical strength or flexibility.

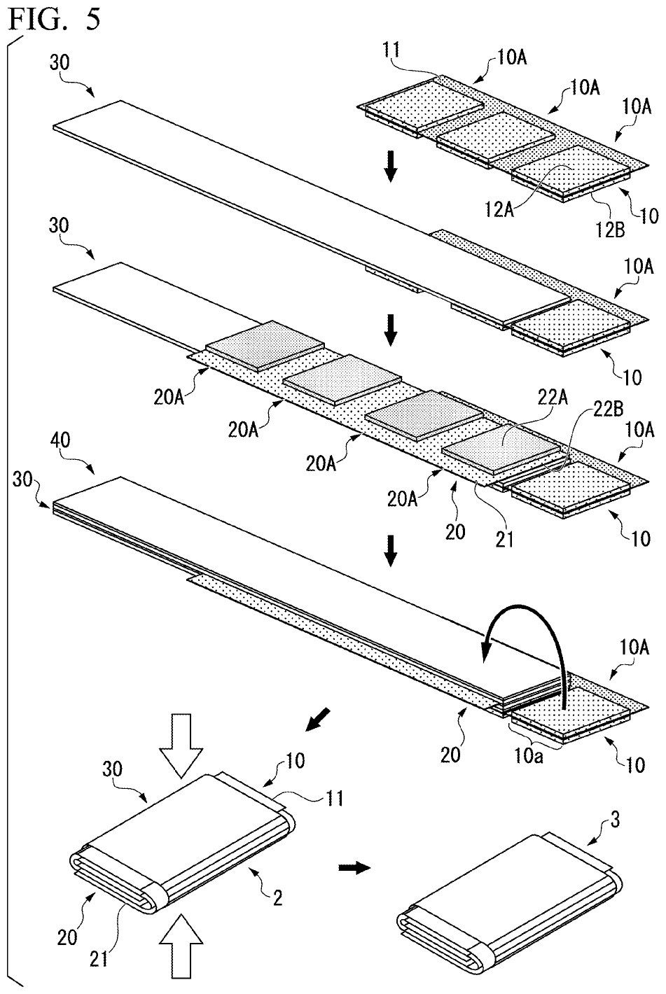

FIG. 5 is a perspective view for explaining an example of a method of manufacturing a wound type battery including the battery electrode group 1 of FIG. 1.

First, a positive electrode mixture is prepared by mixing, for example, a positive electrode active material, a solid electrolyte, a conductive auxiliary agent, and a binder, and a positive electrode mixture slurry in which the positive electrode mixture is dispersed in a predetermined solvent is manufactured. Next, a positive electrode layer precursor (green sheet) is manufactured by intermittently applying the same positive electrode mixture slurry as described above onto the elongated (strip-shaped) positive electrode current collector 11 in the longitudinal direction, the solvent is dried thereafter, which is then compressed using a roll press machine or the like to form the positive electrode active material layers 12A and 12B, and thereby the positive electrode layer 10 having the plurality of positive electrode layer units 10A is manufactured.

In the step of manufacturing the positive electrode layer 10 described above, the positive electrode active material layers can be formed so that a thickness of the positive electrode active material layers 12A and 12B positioned at the longitudinal end portion 10a of the positive electrode layer 10 is larger than thicknesses of the positive electrode active material layers 12A and 12B at positions other than the longitudinal end portion 10a of the positive electrode layer 10. Also, the positive electrode active material layers can be formed so that a basis weight of the positive electrode active material layers 12A and 12B positioned at the longitudinal end portion 10a of the positive electrode layer 10 is larger than basis weights of the positive electrode active material layers 12A and 12B at positions other than the longitudinal end portion 10a of the positive electrode layer 10.

Next, a solid electrolyte slurry in which the solid electrolyte is dispersed in a predetermined solvent is manufactured. Then, a solid electrolyte layer precursor (green sheet) is manufactured by continuously applying the solid electrolyte slurry onto a strip-shaped porous substrate in the longitudinal direction, the solvent is dried thereafter, which is then compressed using a roll press machine or the like, and thereby the first solid electrolyte layer 30 is manufactured.

In the step of manufacturing the first solid electrolyte layer 30 described above, the solid electrolyte layer precursor (green sheet) may also be manufactured by intermittently applying the solid electrolyte slurry onto the strip-shaped porous substrate in the longitudinal direction.

Next, a negative electrode mixture is prepared by mixing, for example, a negative electrode active material, a solid electrolyte, and a binder, and a negative electrode mixture slurry in which the negative electrode mixture is dispersed in a predetermined solvent is manufactured. Then, a negative electrode layer precursor (green sheet) is manufactured by intermittently applying the negative electrode mixture slurry onto the elongated (strip-shaped) negative electrode current collector 21 in the longitudinal direction, the solvent is dried thereafter, which is then compressed using a roll press machine or the like to form the negative electrode active material layers 22A and 22B, and thereby the negative electrode layer 20 having the plurality of negative electrode layer units 20A is manufactured.

Further, similarly to the first solid electrolyte layer 30, a solid electrolyte slurry in which the solid electrolyte is dispersed in a predetermined solvent is manufactured. Then, a solid electrolyte layer precursor (green sheet) is manufactured by continuously applying the solid electrolyte slurry onto a strip-shaped porous substrate in the longitudinal direction, the solvent is dried thereafter, which is then compressed using a roll press machine or the like, and thereby the second solid electrolyte layer 40 is manufactured.

In the step of manufacturing the second solid electrolyte layer 40 described above, the solid electrolyte layer precursor (green sheet) may also be manufactured by intermittently applying the solid electrolyte slurry onto the strip-shaped porous substrate in the longitudinal direction.

Thereafter, in a state in which the positive electrode layer 10, the first solid electrolyte layer 30, the negative electrode layer 20, and the second solid electrolyte layer 40 are laminated in this order, these are wound to form the laminate 2. At this time, the positive electrode layer 10 including the positive electrode active material layers 12A and 12B formed on the elongated positive electrode current collector 11 and the negative electrode layer 20 including the negative electrode active material layers 22A and 22B formed on the elongated negative electrode current collector 21 are laminated in a state of being deviated from each other in the longitudinal direction so that winding start positions of the positive electrode layer 10 and the negative electrode layer 20 are different. For example, when the positive electrode layer 10, the first solid electrolyte layer 30, the negative electrode layer 20, and the second solid electrolyte layer 40 are laminated, respective longitudinal end portions of the first solid electrolyte layer 30, the negative electrode layer 20, and the second solid electrolyte layer 40 are made to be positioned at a reference position L, and only the longitudinal end portion 10a of the positive electrode layer 10 is made to extend from the reference position L (FIG. 2). Then, the longitudinal end portion 10a of the positive electrode layer 10 is folded back by 180 degrees, the positive electrode layer 10 and the negative electrode layer 20 are wound in a flat shape with the longitudinal end portion 10a of the positive electrode layer 10 as a winding core, and thereby the laminate is formed. For example, the positive electrode layer unit 10A positioned at the longitudinal end portion 10a of the positive electrode layer 10 can be folded back to make the positive electrode layer unit 10A a winding core.

In the present embodiment, the positive electrode layer 10 and the negative electrode layer 20 are wound in a flat shape with the longitudinal end portion 10a of the positive electrode layer 10 as a winding core to form the laminate, but the present disclosure is not limited thereto. In a state in which positions of the positive electrode layer 10 and the negative electrode layer 20 are reversely disposed, and the negative electrode layer 20, the first solid electrolyte layer 30, the positive electrode layer 10, and the second solid electrolyte layer 40 are laminated in this order, these may be wound to form a laminate. In this case, the laminate can be formed by winding the positive electrode layer 10 and the negative electrode layer 20 in a flat shape with a longitudinal end portion of the negative electrode layer 20 as the winding core.

In that case, in the step of manufacturing the negative electrode layer 20, the negative electrode active material layer can be formed so that a thickness of the negative electrode active material layers 22A and 22B positioned at the longitudinal end portion of the negative electrode layer 20 are larger than thicknesses of the negative electrode active material layers 22A and 22B at positions other than the longitudinal end portion of the negative electrode layer 20. Also, the negative electrode active material layer can be formed so that a basis weight of the negative electrode active material layers 22A and 22B positioned at the longitudinal end portion of the negative electrode layer 20 are larger than basis weights of the negative electrode active material layers 22A and 22B at positions other than the longitudinal end portion of the negative electrode layer 20.

Thereafter, the laminate 2 is formed by pressing the laminate in a vertical direction using press forming, and thereby the battery electrode group 1 including the laminate 2 is obtained. Thereafter, the positive electrode current collector 11 and the negative electrode current collector 21 of the laminate 2 are respectively connected to external electrodes (not shown). Protective layers (not shown) may be formed on an uppermost layer and a lowermost layer of the laminate 2. Then, the laminate 2 is housed in an exterior material (not shown) such as a film in a sealed state to obtain a wound type battery 3.

As described above, according to the present embodiment, since the longitudinal end portion 10a of the positive electrode layer 10 constitutes the winding core of the laminate 2, the longitudinal end portion 10a of the positive electrode layer 10 as the winding core has higher rigidity than a member such as conventional separators or paper.

Therefore, when pressure is vertically applied with the longitudinal end portion 10a of the positive electrode layer 10 as a center at the time of press-forming the laminate 2, variations in surface pressure applied to the positive electrode layer 10 and the negative electrode layer 20 and a positional deviation therebetween can be suppressed, and variations in initial performance of the wound type battery 3 can be suppressed. Also, when the variations in surface pressure applied to the positive electrode layer 10 and the positional deviation are suppressed, falling off of the positive electrode active material in the positive electrode layer 10 can be suppressed, and a yield of the wound type battery 3 can be improved. Further, since the winding core of the laminate 2 is constituted by the positive electrode layer 10 functioning as a battery, dead space can be eliminated and the volume energy density of the wound type battery 3 can be improved.

While embodiments of the present disclosure have been described above in detail, the present disclosure is not limited to the above embodiments, and various modifications and changes can be made within the gist of the present disclosure described in the claim.

For example, in the above-described embodiment, the battery electrode group 1 includes the first solid electrolyte layer 30 disposed between the positive electrode layer 10 and the negative electrode layer 20, and the second solid electrolyte layer 40 disposed on a side of the negative electrode layer 20 opposite to the first solid electrolyte layer 30, but the present disclosure is not limited thereto. The battery electrode group 1 may include an elongated third solid electrolyte layer integrally disposed on both sides of the positive electrode layer 10 in a bent state or integrally disposed on both sides of the negative electrode layer 20 in a bent state. In this case, for example, the elongated third solid electrolyte layer is bent to be disposed on both sides of the positive electrode layer 10 or disposed on both sides of the negative electrode layer 20, one of the positive electrode layer 10 and the negative electrode layer 20, the third solid electrolyte layer, the other of the positive electrode layer 10 and the negative electrode layer 20, and the third solid electrolyte layer are laminated in this order and wound, and thereby the battery electrode group 1 can be manufactured.

In the above-described embodiment, the battery electrode group 1 is applied to a wound type all-solid-state battery, but the present disclosure is not limited thereto, and may also be applied to a wound type aqueous battery in which charging and discharging are performed via an electrolytic solution. As the wound type aqueous battery, a wound type aqueous lithium ion battery is an exemplary example.

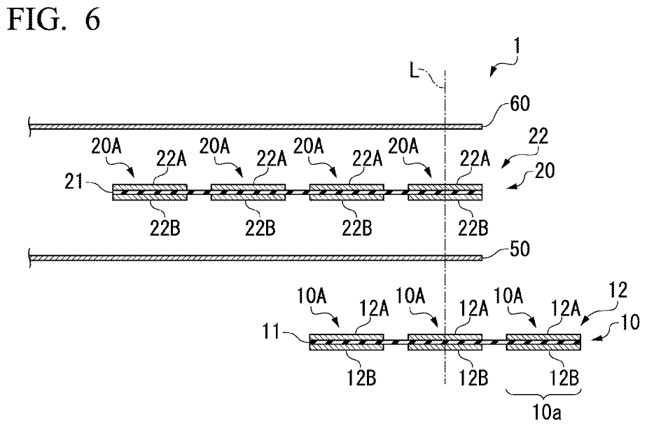

In this case, as shown in FIG. 6, the battery electrode group 1 can include an elongated first separator 50 disposed between the positive electrode layer 10 and the negative electrode layer 20 and an elongated second separator 60 disposed on a side of the negative electrode layer 20 opposite to the first separator 50.

The first separator 50 and the second separator 60 are thin films having insulating properties and are porous bodies formed of a material such as, for example, a polyethylene resin, a polypropylene resin, an aramid resin, or the like. Also, the first separator 50 and the second separator 60 may have a porous body, and a coating layer formed on a surface of the porous body. As the coating layer, for example, a ceramic formed of silicon oxide (SiOₓ), aluminum oxide (Al₂O₃), or the like, an aramid resin, or the like can be used.

According to the present modified example, even when the laminate including the first separator 50 and the second separator 60 is press-formed, since the longitudinal end portion 10a of the positive electrode layer 10 as the winding core has a higher rigidity than that in conventional cases, variations in surface pressure applied to the positive electrode layer 10 and the negative electrode layer 20 and a positional deviation therebetween can be suppressed. Therefore, it is possible to suppress variations in initial performance of the wound type aqueous battery, to improve a yield of the wound type aqueous battery, and to improve the volume energy density of the wound type aqueous battery.

In the above-described modified example, the battery electrode group 1 includes the elongated first separator 50 disposed between the positive electrode layer 10 and the negative electrode layer 20 and the elongated second separator 60 disposed on a side of the negative electrode layer 20 opposite to the first separator 50, but the present disclosure is not limited thereto. The battery electrode group 1 may include a third separator integrally disposed on both sides of the positive electrode layer 10 in a bent state or integrally disposed on both sides of the negative electrode layer 20 in a bent state. In this case, for example, the elongated third separator is bent to be disposed on both sides of the positive electrode layer 10 or disposed on both sides of the negative electrode layer 20, one of the positive electrode layer 10 and the negative electrode layer 20, the third separator, the other of the positive electrode layer 10 and the negative electrode layer 20, and the third separator are laminated in this order and wound, and thereby the battery electrode group 1 can be manufactured.

Further, the battery electrode group of the present disclosure can be applied to batteries of various types such as a primary battery and a secondary battery. Also, the wound type battery of the present disclosure can be applied to electric vehicles (EV) such as two-wheeled vehicles and four-wheeled vehicles and is particularly suitable for electric automobiles or hybrid vehicles.

While preferred embodiments of the invention have been described and shown above, it should be understood that these are exemplary of the invention and are not to be considered as limiting. Additions, omissions, substitutions, and other modifications can be made without departing from the spirit or scope of the present disclosure. Accordingly, the invention is not to be considered as being limited by the foregoing description and is only limited by the scope of the appended claims.

What is claimed is:

1. A battery electrode group formed of a laminate which includes a positive electrode layer having a positive electrode active material layer formed on an elongated positive electrode current collector and a negative electrode layer having a negative electrode active material layer formed on an elongated negative electrode current collector, and in which the positive electrode layer and the negative electrode layer are wound in a flat shape, wherein
one of a longitudinal end portion of the positive electrode layer and a longitudinal end portion of the negative electrode layer constitutes a winding core of the laminate.

2. The battery electrode group according to claim 1, wherein
the positive electrode layer includes:
the elongated positive electrode current collector; and
a plurality of positive electrode active material layers intermittently formed on at least one main surface of the positive electrode current collector,
the negative electrode layer includes:
the elongated negative electrode current collector; and
a plurality of negative electrode active material layers intermittently formed on at least one main surface of the negative electrode current collector, and
the plurality of positive electrode active material layers and the plurality of negative electrode active material layers are alternately disposed with respect to a lamination direction of the laminate in a state in which the positive electrode layer and the negative electrode layer are wound.

3. The battery electrode group according to claim 1, wherein
a thickness of the positive electrode active material layer positioned at the longitudinal end portion of the positive electrode layer is larger than thicknesses of the positive electrode active material layers at positions other than the longitudinal end portion of the positive electrode layer, or
a thickness of the negative electrode active material layer positioned at the longitudinal end portion of the negative electrode layer is larger than thicknesses of the negative electrode active material layers at positions other than the longitudinal end portion of the negative electrode layer.

4. The battery electrode group according to claim 1, wherein
a basis weight of the positive electrode active material layer positioned at the longitudinal end portion of the positive electrode layer is larger than basis weights of the positive electrode active material layers at positions other than the longitudinal end portion of the positive electrode layer, or
a basis weight of the negative electrode active material layer positioned at the longitudinal end portion of the negative electrode layer is larger than basis weights of the negative electrode active material layers at positions other than the longitudinal end portion of the negative electrode layer.

5. The battery electrode group according to claim 1, comprising:
a first solid electrolyte layer disposed between the positive electrode layer and the negative electrode layer; and
a second solid electrolyte layer disposed on a side of the negative electrode layer opposite to the first solid electrolyte layer.

6. The battery electrode group according to claim 1, further comprising an elongated third solid electrolyte layer integrally disposed on both sides of the positive electrode layer in a bent state or integrally disposed on both sides of the negative electrode layer in a bent state.

7. The battery electrode group according to claim 1, further comprising:
an elongated first separator disposed between the positive electrode layer and the negative electrode layer; and
an elongated second separator disposed on a side of the negative electrode layer opposite to the first separator.

8. The battery electrode group according to claim 1, further comprising an elongated third separator integrally disposed on both sides of the positive electrode layer in a bent state, or integrally disposed on both sides of the negative electrode layer in a bent state.

9. A wound type battery comprising a battery electrode group according to claim 1.

10. A method of manufacturing a battery electrode group, wherein
a positive electrode layer including a positive electrode active material layer formed on an elongated positive electrode current collector and a negative electrode layer including a negative electrode active material layer formed on an elongated negative electrode current collector are laminated in a state of being deviated from each other in a longitudinal direction so that winding start positions of the positive electrode layer and the negative electrode layer are different, and
the positive electrode layer and the negative electrode layer are wound in a flat shape to form a laminate using any one of a longitudinal end portion of the positive electrode layer and a longitudinal end portion of the negative electrode layer as a winding core.

11. The method of manufacturing a battery electrode group according to claim 10, wherein
the positive electrode layer is manufactured by intermittently forming a plurality of positive electrode active material layers on at least one main surface of the positive electrode current collector,
the negative electrode layer is manufactured by intermittently forming a plurality of negative electrode active material layers on at least one main surface of the negative electrode current collector, and
the plurality of positive electrode active material layers and the plurality of negative electrode active material layers are alternately disposed with respect to a lamination direction of the laminate by winding the positive electrode layer and the negative electrode layer.

12. The method of manufacturing a battery electrode group according to claim 10, wherein
the positive electrode active material layers are formed so that a thickness of the positive electrode active material layer positioned at the longitudinal end portion of the positive electrode layer is larger than thicknesses of the positive electrode active material layers at positions other than the longitudinal end portion of the positive electrode layer, or
the negative electrode active material layers are formed so that a thickness of the negative electrode active material layer positioned at the longitudinal end portion of the negative electrode layer is larger than thicknesses of the negative electrode active material layers at positions other than the longitudinal end portion of the negative electrode layer.

13. The method of manufacturing a battery electrode group according to claim 10, wherein
the positive electrode active material layers are formed so that a basis weight of the positive electrode active material layer positioned at the longitudinal end portion of the positive electrode layer is larger than basis weights of the positive electrode active material layers at positions other than the longitudinal end portion of the positive electrode layer, or
the negative electrode active material layers are formed so that a basis weight of the negative electrode active material layer positioned at the longitudinal end portion of the negative electrode layer is larger than basis weights of the negative electrode active material layers at positions other than the longitudinal end portion of the negative electrode layer.

14. The method of manufacturing a battery electrode group according to claim 10, wherein
a first solid electrolyte layer is disposed between the positive electrode layer and the negative electrode layer, and a second solid electrolyte layer is disposed on a side of the negative electrode layer opposite to the first solid electrolyte layer, and
one of the positive electrode layer and the negative electrode layer, the first solid electrolyte layer, the other of the positive electrode layer and the negative electrode layer, and the second solid electrolyte layer are laminated in this order and wound.

15. The method of manufacturing a battery electrode group according to claim 10, wherein
an elongated third solid electrolyte layer is bent to be disposed on both sides of the positive electrode layer or disposed on both sides of the negative electrode layer, and
one of the positive electrode layer and the negative electrode layer, the third solid electrolyte layer, the other of the positive electrode layer and the negative electrode layer, and the third solid electrolyte layer are laminated in this order and wound.

16. The method of manufacturing a battery electrode group according to claim 10, wherein
an elongated first separator is disposed between the positive electrode layer and the negative electrode layer, and an elongated second separator is disposed on a side of the negative electrode layer opposite to the first separator, and
one of the positive electrode layer and the negative electrode layer, the first separator, the other of the positive electrode layer and the negative electrode layer, and the second separator are laminated in this order and wound.

17. The method of manufacturing a battery electrode group according to claim 10, wherein
an elongated third separator is bent to be disposed on both sides of the positive electrode layer or disposed on both sides of the negative electrode layer, and
one of the positive electrode layer and the negative electrode layer, the third separator, the other of the positive electrode layer and the negative electrode layer, and the third separator are laminated in this order and wound.

18. A wound type battery comprising a battery electrode group manufactured by the manufacturing method according to claim 10.
